(19) United States
(12) Patent Application Publication
(10) Pub. No.: US 2010/0296992 A1
(43) Pub. Date: Nov. 25, 2010

(54) Honeycomb Catalyst And Catalytic Reduction Method

(76) Inventors: Yi Jiang, Horseheads, NY (US); Ameya Joshi, Painted Post, NY (US); Steven Bolaji Ogunwumi, Painted Post, NY (US); Jianhua Weng, Painted Post, NY (US)

Correspondence Address: CORNING INCORPORATED, SP-TI-3-1, CORNING, NY, 14831, US

(21) Appl. No.: 12/470,938

(22) Filed: May 22, 2009

(51) Int. Cl. B01D 53/56; B32B 3/12; B01J 29/06; B01J 29/18; B01D 53/86

(52) U.S. Cl. 423/239.2; 428/116; 502/60; 502/77; 502/78; 423/239.1

(57) ABSTRACT

Honeycomb catalyst structures and methods of using them, where the structures have honeycomb channel walls of selective catalytic reduction catalyst, the channel walls occupy at least 20% of the volume of the structure, the structure exhibits a pressure drop for flowing air not exceeding about 110 Pa at a space velocity of 20,000 hr⁻¹, and the channel walls are of a thickness insuring high degree of catalyst utilization and NOx conversion efficiency.

### BACKGROUND

The disclosed catalysts and methods relate to the reduction of nitrogen oxides generated during high temperature combustion processes, particularly including the treatment of the NOₓ-containing exhaust streams from mobile emissions sources such as motor vehicles.

### SUMMARY

The disclosed catalysts and catalytic methods provide high NOx removal efficiencies in motor vehicle exhaust system environments, provide increased levels of catalyst utilization to reduce catalyst costs, and provide reduced exhaust system pressure drops to minimize catalyst system fuel consumption penalties.

### BRIEF DESCRIPTION OF THE DRAWINGS

The disclosed catalysts and methods are further described below with reference to the appended drawings, where:

FIG. 1 shows actual and modeled honeycomb NOx conversion efficiencies versus honeycomb inlet temperatures for selected honeycomb SCR catalysts;

FIG. 2 shows exhaust gas pressure drop versus exhaust gas inlet velocity for selected honeycomb SCR catalysts;

FIG. 3 shows NOx conversion and catalyst utilization levels against honeycomb channel wall thickness for selected honeycomb SCR catalysts;

FIG. 4 shows NOx conversion level versus a first catalyst performance index for selected honeycomb SCR catalysts;

FIG. 5 shows NOx conversion level versus a second catalyst performance index for selected honeycomb SCR catalysts; and

FIG. 6 shows a representative honeycomb configuration for a honeycomb SCR catalyst.

### DETAILED DESCRIPTION

The efficiencies of honeycomb catalyst structures employed for the reduction of nitrogen oxides in SCR reactions are governed by a number of factors, including the composition or reactivity of the catalyst, the loading of catalyst into the structure, the geometry and microstructure of the honeycomb, and the upstream exhaust flow spatial conditions including the composition, temperature, and flow distribution of the exhaust. For any given set of exhaust flow conditions and given catalyst of predeterined reactivity and microstructure, the conversion efficiency, pressure drop, and catalyst cost will be determined by honeycomb geometry (i.e., cell density, channel wall thickness, diameter, and length) and catalyst loading.

While conversion efficiencies can be increased for any particular honeycomb catalyst design by increasing catalyst loading and cell density, the catalyst costs for the resulting structures can be high and the levels of catalyst utilization are reduced. Additionally, the increased pressure drops across the thus-modified structures can incur unacceptable increases in exhaust system backpressure, and thus cause problematic reductions in engine power output and fuel economy.

Nitrogen oxides (NOₓ) are by-products of the combustion of carbonaceous fuels in air, and together with unburned hydrocarbons and carbon monoxide are the targets of government regulations limiting polluting emissions from motor vehicles. In conventional gasoline engines, governmental limits are being met through the use of so-called “three-way” catalysts, generally precious metal catalysts that are dispersed in catalytic coatings applied to refractory monolithic (honeycomb) supports contained in automobile catalytic converters. However, such catalysts are not adequate for the removal of the higher NOx concentrations that are typically found in diesel and lean-bum gasoline engine exhausts.

A different technology, based on the selective catalytic reduction (SCR) of nitrogen oxides using ammonia as a reductant, has been developed for the removal of NOₓ from stack gases emitted by fossil-fuel-fired power plants. Adapting the SCR process for NOₓ reduction from gasoline and diesel engine exhaust gases is a current area of development.

Several different catalyst compositions and products have been proposed for use in SCR processes, including precious metals, base metal oxides of tungsten, vanadium, and titanium, and zeolite-based materials including Fe— and Cu-impregnated zeolites. Product configurations vary with the application but have included beads, plates and honeycombs.

Effective SCR systems for mobile emissions control applications must provide high deNOx performance (desirably a complete conversion of the NOx compounds present in the exhaust to N₂). However low catalyst loadings are desirable in order to limit system costs. Good mechanical strength and thermal durability are also needed to enable the catalysts to survive handling, canning, and vibration and thermal cycling in use. At the same time, catalyst configurations that can facilitate low exhaust backpressure are needed to maintain engine efficiency and fuel economy.

One approach that has been suggested for adapting SCR processes to the treatment of automobile exhaust gases has involved applying SCR catalyst coatings to ceramic honeycomb supports such as currently used to support three-way automobile exhaust catalysts. However, catalyst coatings provide only modest catalyst loadings when compared with extruded SCR catalysts, and thus offer only limited conversion efficiencies, especially at low temperatures or low exhaust gas flow rates. Higher heat capacities for better thermal shock resistance, reduced exhaust back-pressures for improved fuel economy, higher resistance to catalyst loss through spalling of the catalyst coatings, and reduced unit weight and volumne due to elimination of the inert ceramic support, are other advantages that could potentially flow from the use of extruded rather than coated catalysts. Avoiding the process and supply chain costs associated with the need to employ coating processes and equipment would also be attractive.

Unfortunately most present designs for extruded honeycomb SCR catalysts, including those currently used in power plant stack gas treatment systems, are not suitable for use in mobile emissions control applications. Among other shortcomings, such catalysts do not provide the conversion efficiencies required to meet current and proposed environmental regulations limiting NOx emissions from diesel and/or lean bum gasoline engines, particularly at the relatively high exhaust gas flows typical of such engines. Thus while extensive attention has been focused on understanding the relationship between catalyst composition and efficient SCR NOx reduction, SCR catalysts and catalytic treatment methods employing SCR NOx control that combine a high level of NOx reduction with low exhaust system pressure drop, low cost, good mechanical and thermal durability, and a high level of catalyst utilization to minimize catalyst cost have yet to be provided.

The catalysts hereinafter disclosed are honeycomb monoliths of solid SCR catalytic material, formed for example by the extrusion of plasticized catalyst formulations from honeycomb extrusion dies. A typical honeycomb 10 as illustrated in FIG. 6 of the accompanying drawings comprises an array of adjoining parallel channels 12 bounded by thin interconnecting channel walls or webs 14, the channels being open-ended and extending from a first or exhaust gas inlet end 16 of the honeycomb structure to a second or exhaust gas outlet end 18 of the structure.

To provide high NOx removal efficiency, the honeycomb structures incorporate a volume of catalyst sufficient to allow for the diffusion and reduction of NOx by a suitable reductant at active reduction sites within the channel walls even at high exhaust gas flow rates. However, the volume fraction of catalyst is not so large as to include excess catalytic material that is substantially inaccessible to NOx reactant diffusion at those flow rates, or that acts to obstruct exhaust flow and thus increase pressure drop across the honeycomb structure. Thus the volume fraction of actively functioning catalyst in the structure, i.e., the catalyst utilization factor, is high.

Embodiments of honeycomb catalysts providing these characteristics of the disclosure include honeycomb structures having channel walls consisting essentially of selective catalytic reduction catalyst, and where the channel walls occupy at least 20% of the volume of the structure. The weight and distribution of the channel walls within the honeycomb structures are selected such that the structures exhibit a pressure drop for flowing air not exceeding 110 Pa at a space velocity of 20,000 hr⁻¹, for example at a honeycomb channel length of 15 cm. For the purposes of this disclosure the terms “selective catalytic reduction catalyst” and “SCR catalyst” include both pure catalysts and dispersions of such catalysts in solid matrix materials or fillers that can bind, support and secure the pure catalysts to or into the walls of the honeycomb catalysts. Examples of powdered matrix materials that can be used as fillers or binders for this purpose include alumina, cordierite, zircon, zirconia, mullite and the like.

Pressure drops through the honeycomb structures are controlled principally through appropriate selections of channel wall thickness, honeycomb cell density, and channel length. Honeycomb cell densities are defined in terms of the number of honeycomb channels per unit of honeycomb cross-sectional area as measured in a plane perpendicular to the direction of channel orientation in the honeycomb in accordance with standard practice. Specific embodiments of the disclosed catalysts have channel wall thicknesses not exceeding 250 microns, such thicknesses being effective to maintain high catalyst utilization factors even at gas flow rates typical of motor vehicle exhaust systems. Thus the disclosure includes embodiments of the above-described catalysts that provide a nitrogen oxide conversion efficiency of at least 45% when processing a combustion exhaust gas mixture comprising 500 ppm (volume) of ammonia and 500 ppm (volume) of nitrogen oxide (NO) at a gas mixture or reaction temperature of 250° C. and a space velocity of 20,000 hr⁻¹.

The disclosure additionally includes methods for treating gas streams comprising nitrogen oxide pollutants utilizing the disclosed honeycomb catalyst structures. Embodiments of those methods include a method for treating a gas stream to remove nitrogen oxides therefrom comprising the steps of introducing a nitrogen oxide reductant into the gas stream, and passing the gas stream having the reductant through a honeycomb structure having channel walls consisting essentially of a selective catalytic reduction catalyst as herein described. The selective catalytic reduction catalyst used in the practice of the disclosed methods occupies at least 20% of the volume of the structure and the structure exhibits a pressure drop for flowing gas (e.g., room temperature air) not exceeding 110 Pa at a space velocity of 20,000 hr⁻¹, for example at honeycomb channel lengths of up to 15 cm.

The disclosed concepts can be applicable to a wide variety of SCR catalysts and NOx exhaust stream conditions. However, they can be particularly applied to the design of extruded honeycomb catalysts of or zeolytic or molecular sieve composition. Zeolites and other such catalysts can be adapted for use in methods to treat combustion engine exhaust gases. The disclosed concepts can be applied to the selection of honeycomb monolith cell densities and channel wall thicknesses for extruded flow-through honeycomb catalysts, which cell densities and wall thicknesses can deliver high-level deNOx performance with ammonia-based reductants, at low pressure drops, and reduced catalyst costs. Thus the following descriptions and examples refer particularly to such catalysts and methods even though the concepts involved are not limited thereto.

Selective catalytic reduction (SCR) processes are known to involve the catalytic reduction of nitrogen oxides with ammonia or an ammonia source in the presence of atmospheric oxygen, to produce nitrogen and steam. The following reactions are illustrative:

4 NO+4 NH₃+O₂→4N₂+6 H₂O

2 NO₂+4 NH₃+O₂→3N₂+6 H₂O

NO+NO₂+2NH₃→2N₂+3 H₂O

In extruded honeycomb catalysts, these SCR reactions occur within the porous channel walls or webs of the monolithic structure. Thus after overcoming mass transfer limitations affecting the transfer of reactant gases from the flowing gas stream to the channel walls, the gases must then diffuse from the outer wall surfaces through and into the interiors of the pores in order to reach active catalyst sites. Then, once reaction occurs, the reaction products must traverse the reverse path while overcoming similar mass transfer resistance. The performance of any monolithic catalytic structure is therefore limited by the extent to which the reacting gases can reach active catalyst sites via pore diffusion. In the foregoing the heavier catalyst loadings can involve longer diffusion path lengths for gaseous reactants, and therefore the SCR conversion improvements resulting from higher catalyst loadings will not necessarily be in proportion to the amounts of catalyst added. This effect can be numerically represented by a value referred to herein as a catalyst utilization factor. A useful catalyst utilization factor can be calculated from an expression such as:

$$Catalyst Utilization = \frac{SCR performance with pore diffusion limitations}{SCR performance without pore diffusion limitations}$$

wherein SCR performance is measured in terms of percent of NOx conversion under specified exhaust gas inlet conditions. The denominator in the above expression refers to catalyst performance under a hypothetical situation where the gaseous reactant gases come in contact with all of the reactive sites in the catalyst as soon as the gases touch the channel wall. That performance can be calculated utilizing known honeycomb catalyst modeling tools such as by “turning off” pore diffusion resistance in the models, for example by making pore diffusion infinitely fast.

Commercial models that simulate the catalytic performance of catalyst-coated honeycomb supports can be adapted to model extruded honeycomb SCR catalysts. Examples of suitable modeling software include the DETCHEM™ software packages, e.g., DETCHEM™ Software Ver. 2.1, O. Deutschmann, et. al., eds., www.detchem.com, Karlsruhe 2007.

The DETCHEM software includes a module for modeling flow-through substrates incorporating catalyzed washcoat layers. Adapting that module to the modeling of the disclosed extruded solid honeycomb catalysts involves treating the channel walls of the honeycomb as an “apparent washcoat”, with the distribution of catalyst across the thickness of those channel walls assumed to be uniform. The original and adapted models both assume identical conditions within each channel of the honeycomb structures, with negligible axial dispersion.

The kinetics for the above NOx reduction reactions as determined from bench tests of honeycomb structures extruded from selected SCR catalysts can be factored into the equations to produce a fully two-dimensional transient two-phase mathematical model of an SCR honeycomb monolith reactor. No further adjustments are required for the model to accurately project honeycomb catalyst performance over a relatively wide range of catalyst loadings, honeycomb geometries, and gas flow rates.

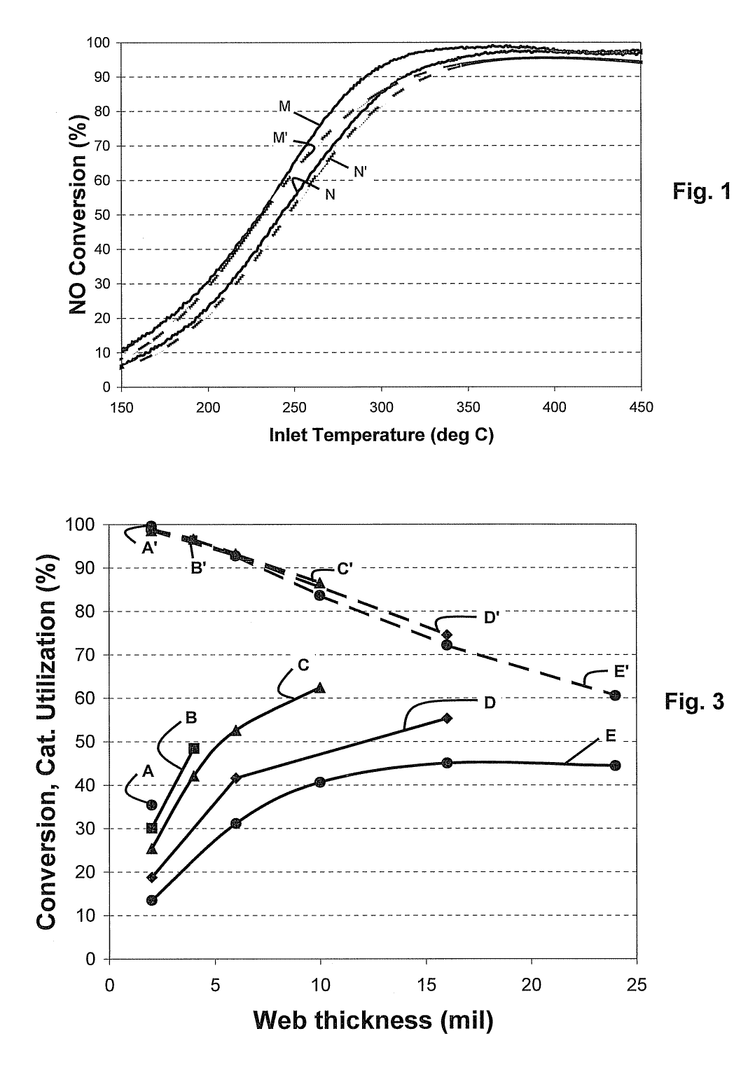

FIG. 1 compares representative bench test conversion data with projected (modeled) conversion performance for two extruded zeolite honeycomb catalysts of differing honeycomb geometry after hydrothermal aging. Conversion efficiencies are reported as percent conversions of NOx present in a synthetic exhaust gas stream, reported on the y-axis, over a range of honeycomb inlet temperatures from 150° C. to 450° C. reported on the x-axis. The two honeycomb geometries for the catalyst designs evaluated in FIG. 1 include a first geometry (Curves M and M′) having a channel wall thickness of 0.010 inches, and a second geometry (Curves N and N′) having a channel wall thickness of 0.006 inches. Both geometries were of cell densities of 400 channels/in² of honeycomb cross-section.

The synthetic exhaust gas used for testing and modeling comprises 500 ppm (volume) of nitrogen oxide (NO) and 500 ppm (volume) of ammonia in air, that mixture being passed through the honeycomb catalysts at actual or modeled space velocities of 20,000 hr⁻¹. Each of the extruded honeycomb catalyst designs evaluated consists of a cylindrical shape 2.5 cm in diameter by 2.5 cm in length with the honeycomb channels running parallel with the cylinder length.

The modeled conversion results for each of the two honeycomb geometries evaluated in FIG. 1 are represented by dashed curves M′ and N′, while the bench test results are represented by solid curves M and N. The data thus presented clearly confirm the validity of the adapted models, in that the modeled conversion results conform closely to the bench test results for both of the honeycomb geometries evaluated.

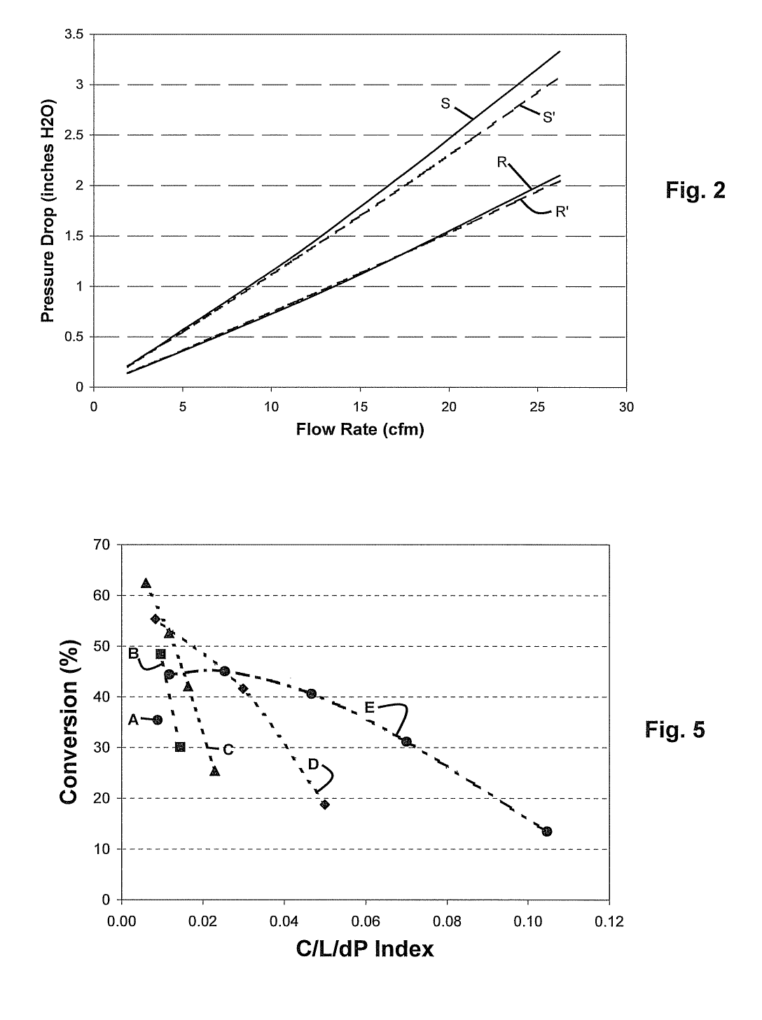

Further validation of the adapted models is provided by tests designed to track honeycomb pressure drops as a function of gas flow rate through the honeycombs. FIG. 2 of the drawings plots modeled and bench test data for two honeycomb catalyst designs having the same cell density but different wall thicknesses. The honeycomb samples evaluated are of the same exterior dimensions and channel orientation as the honeycombs characterized in FIG. 1 of the drawings. The first design, characterized by Curves R and R′ in FIG. 2, has a channel wall thickness of 0.004 inches, while the second design, characterized by Curves S and S′, has a channel wall thickness of 0.010 inches. Both of the evaluated designs have cell densities of 400 cells/in² of honeycomb cross-sectional area as measured transverse to the direction of channel orientation.

The measured and calculated pressure drops for the honeycomb catalysts evaluated in FIG. 2 are reported in inches of water on the y-axis, while gas flow rates for the catalysts are reported in cubic feet per minute on the x-axis. FIG. 2 demonstrates a good correspondence between the bench test results for the two designs, indicated by the solid lines R and S, and the modeled results, indicated respectively by the broken lines R′ and S′. Thus these data further confirm the value of the adapted models as useful tools for projecting the performance of honeycomb SCR catalysts over a wide range of geometric design parameters.

For honeycomb catalysts having channel walls formed entirely or substantially entirely of catalyst-bearing material, higher deNOx performance is generally associated with either increased catalyst content, e.g., higher catalyst concentrations per unit volume of honeycomb catalyst, which are expensive in terms of catalyst cost, or with higher pressure drops, which are expensive in terms of higher fuel consumption penalties. The data presented in FIGS. 1 and 2 of the drawings illustrate these effects. Thus the honeycomb catalyst of 400/10 (cell density/wall thickness) design (Curves M and M′ in FIG. 1), with a catalyst content of 36% by volume, exhibits higher conversion efficiency at equivalent inlet temperatures than the 400/6 design (Curves N and N′), with a catalyst content of 25% by volume. On the other hand, the honeycomb catalyst design of FIG. 2 having the higher channel wall thickness (the 400/10 honeycomb design of Curves R and R′) exhibits substantially higher pressure drops at equivalent gas flow rates than the 400/4 design of Curves S and S′.

A further disadvantage of increased catalyst loading in solid SCR catalysts is that, due to gas diffusion limitations such as discussed above, the level of catalyst utilization decreases with increasing catalyst or channel wall thickness even though some increases in conversion efficiency may be realized. These competing effects are illustrated by the NOx conversion and catalyst utilization data reported in FIG. 3 of the drawings.

The catalyst samples analyzed to provide the data plotted in FIG. 3 fall into five separate families A through E, each family comprising one or more samples of the same cell density but differing channel wall thickness. Each of the solid curves labeled A through E in FIG. 3 plot conversion results for one family in percent of NO conversion on the y-axis as a function of channel wall or web thickness on the x-axis. Each of the broken line curves labeled A′ through E′ plots catalyst utilization factors (in percent utilization) on the y-axis as a function of channel wall (web) thickness on the x-axis for the same families of catalyst samples. The conversion percentages reported in FIG. 3 are for a synthetic exhaust gas having the composition, space velocity, and temperature of the exhaust gas used to generate the model and bench test conversion data shown in FIG. 1 of the drawings. Table I below reports the cell densities of each of the five families characterized in FIG. 3

TABLE I
Honeycomb Catalyst Geometries

| Catalyst | Cell Density |
|---|---|
| Identification | (cells/in²) |
| A, A′ | 900 |
| B, B′ | 600 |
| C, C′ | 400 |
| D, D′ | 200 |
| E, E′ | 100 |

As the modeled catalyst utilization data in FIG. 3 suggest, the degrees of catalyst utilization in these honeycomb catalyst designs (broken line curves) are found to decrease with increasing channel wall thickness for each of the series evaluated. As expected the catalyst utilization values are found to be substantially independent of honeycomb catalyst cell density. While other factors must also be taken into account in designing a honeycomb catalyst suited for the control of engine exhaust emissions, the value of maintaining a high degree of catalyst utilization to control catalyst cost is evident from these data.

The discovery of honeycomb catalyst configurations of high NOₓ conversion efficiency, but with the controlled catalyst loadings and limited pressure drops required for economic diesel and lean burn engine NOₓ emissions control, has required further studies of catalyst performance data involving novel indices of catalyst performance. The first such performance index, referred to as a conversion/loading index (C/L Index), corresponds to a ratio of NOx conversion level to catalyst loading for each of a number of selected honeycomb catalyst design to be evaluated. That index provides a basis for comparing those designs over a range of catalyst loading levels and corresponding conversion levels to identify designs offering higher than expected conversion activity for a given level of catalyst loading.

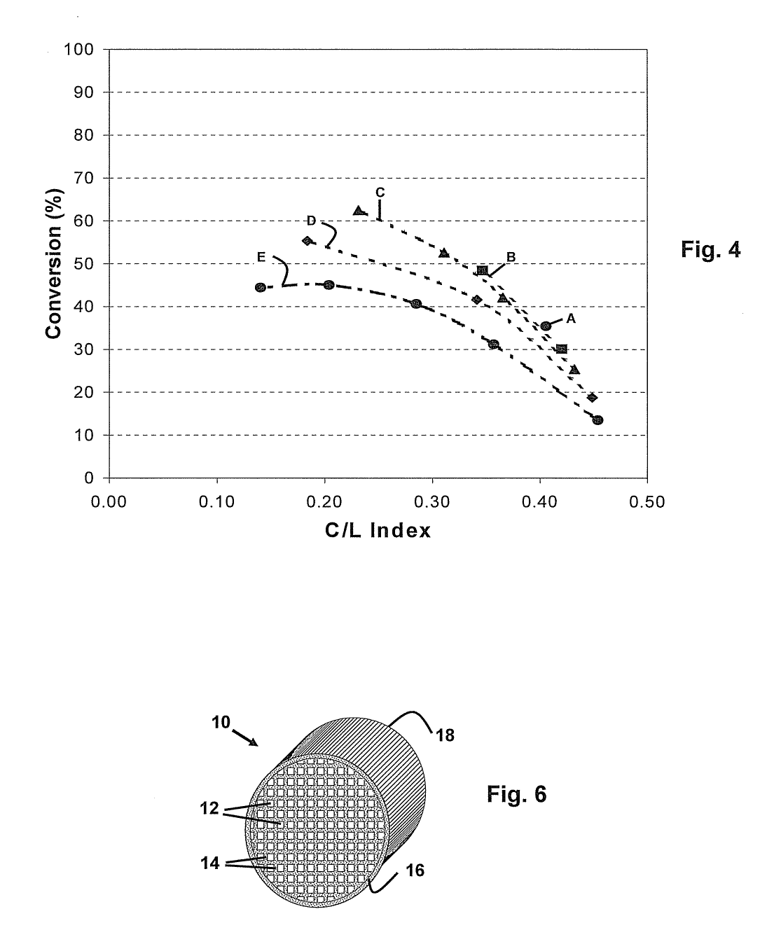

FIG. 4 plots modeled NOx conversion activity (y-axis) for five families of honeycomb catalyst design over a broad range of conversion/loading (C/L Index) values (x-axis). Broken line curves labeled A-E connect data points within each family comprising multiple evaluation samples; the cell densities are invariant within each family, and correspond to the densities reported for honeycomb designs A-E in Table I above. The C/L index values increase from left to right along the x-axis of the graph, reflecting decreasing channel wall thicknesses, and thus decreasing catalyst loadings, in that direction on the graph. All NOₓ conversion values in Table 4 are calculated for a synthetic exhaust gas composition, space velocity, and gas processing temperature as described above in connection the generation of the data illustrated in FIG. 1.

As the curves in FIG. 4 suggest, there are substantial differences in the levels of NOx conversion observed among honeycomb catalyst designs having equivalent conversion/loading indices. Designs that exhibit higher levels of NOx removal will be of primary interest for further development. However, evaluating competing designs in terms of the C/L Index can also be helpful in identifying honeycomb designs that provide only marginal NOx conversion levels (e.g., conversions below 45% of NO at a 250° C. inlet temperature) even at high catalyst loadings. The 100 cpsi designs plotted in FIG. 4 are examples of the latter designs.

The second performance index of interest for evaluating honeycomb catalyst designs, termed a conversion/loading/pressure drop (C/L/dP) index, adds a pressure drop dimension to the above C/L evaluation analysis. That index, consisting of a ratio of conversion level to catalyst loading to pressure drop for each of the evaluated designs, provides an approach for comparing designs of similar catalyst loading (and therefore roughly equivalent catalyst cost) to identify design solutions offering higher conversion efficiencies yet lower pressure drops at a given loading level.

FIG. 5 of the drawings plots modeled NOx conversions (y-axis) for a number of different honeycomb catalyst designs over a range of C/L/dP Index values (x-axis). The honeycomb designs evaluated comprise the same five families of catalyst design A-E reported in Table I above and characterized in FIG. 4 above, with the broken line curves connecting data points within each family in FIG. 4 again being correspondingly labeled. All NOₓ conversion values are again calculated for a synthetic exhaust gas composition, space velocity, and gas processing temperature equivalent to that described above in connection with the data reported in FIGS. 1.

As indicated in FIG. 5, the C/L/dP Index values increase from left to right on the x-axis, being dominated by decreases in catalyst loading resulting from decreases in channel wall thickness in that direction. For the overall C/L/dP Index, however, the increases in index value are moderated by the changing pressure drop (dP) values, these also decreasing from left to right as a consequence of the reductions in channel wall thickness.

Catalyst cost considerations alone could suggest the selection of catalysts with higher C/L/dP indices from this design space, but NOx conversion requirements will limit the number of satisfactory design choices to those of somewhat lower C/L/dP Index, i.e., of higher catalyst loading. Advantageously, from among the latter choices, the data permit the identification of designs with higher conversion activity and lower pressure drop that will still meet a selected required minimum NOx conversion level. Thus the data permit the design of new honeycomb catalyst configurations that correctly balance the competing considerations of catalyst cost, honeycomb pressure drop, and NOx conversion effectiveness.

The disclosed catalysts and catalyst methods include embodiments wherein the honeycomb structure includes a selective catalytic reduction catalyst of zeolitic or molecular sieve structure. Specific examples include those where the catalyst can be selected from the group consisting of beta zeolite, ZSM-5 zeolite, mordenite, silico-aluminophosphates, metal-impregnated zeolites including, for example, copper- or iron-zeolites, and combinations thereof. These and similar zeolitic catalysts can be used to make embodiments of honeycomb catalyst structures which, when processing a gas mixture comprising a combination of 500 ppm (volume) of ammonia and 500 ppm (volume) of nitrogen oxide (NO) in air at at a space velocity of 20,000 hr⁻¹ and a gas temperature of 250° C. at the catalyst inlet surface, provide a nitrogen oxide conversion efficiency of at least 45% within a honeycomb channel length of 15 cm. For the purposes of the disclosure, effective NOₓ conversions will extend to conversions of any of nitric oxide (NO₂), nitrogen oxide (NO), nitrous oxide (N₂O), and mixtures thereof, provided only that the gas mixture includes stoichiometrically sufficient proportions of ammonia or an ammonia source, such as urea, to substantially complete the reductions.

Further embodiments of the disclosed catalysts include honeycomb catalyst structures having a honeycomb channel length of at least 15 cm, as well as honeycomb catalyst structures having catalyst utilization factors of at least 80%. Structures having channel walls of a thickness not exceeding about 250 microns as described above can readily meet this high catalyst utilization level if the walls are sufficiently porous to be gas-permeable.

As noted above, the discovery of honeycomb catalyst structures having design parameters offering high conversion efficiencies in combination with moderate pressure drop and reasonable catalyst cost has been enabled by analyses of conversion data including performance index curves such disclosed in FIGS. 4 and 5. Particular embodiments of catalysts developed from such analyses generally include honeycomb catalyst structures having a cell density of at least 350 channels per square inch of transverse honeycomb cross-section, e.g., from about 350 to as many as 600 channels per square inch of a transverse honeycomb cross-section, and with channel wall thicknesses not exceeding about 250 mircrons, e.g., from 100-250 microns. Again, the honeycomb catalyst structure may be formed entirely of an SCR catalyst, but more typically will be a structure comprising the selective catalytic reduction catalyst distributed within the channel walls of the structure in a supporting matrix of a material, such as cordierite or alumina, that is typically catalytically inert or substantially inert with respect to nitrogen oxide conversion.

Embodiments of the above-described catalysts can readily meet the prescribed pressure drop and NO conversion characteristics, for example in unitary structures of 15 cm channel length or greater. However, where the properties of the selected SCR catalyst are such as to favor honeycomb catalyst manufacture in segments of shorter length, suitable honeycomb catalyst structures can be composite structures of whatever lengths are required for the particular application of interest. An example of such a structure is one made up of a stack of channel-aligned honeycomb slices providing a combined channel length of the selected magnitude. References to honeycomb catalyst structures in the disclosure are thus intended to include such composite catalyst structures where the selected channel lengths require it.

Methods for treating gas streams to remove nitrogen oxides in accord with the disclosure include those wherein the gas stream is a combustion exhaust gas such as produced by a fossil-fuel powered rotary, turbine or piston engine, and where the nitrogen oxides in the exhaust gas include at least one of NO and NO₂. Embodiments of such methods particularly include those wherein the reductant for nitrogen oxide removal in accordance with SCR processing is ammonia, or an ammonia source such as urea. Again, embodiments of the disclosed methods wherein the catalyst comprises a zeolite or zeolitic or molecular sieve material, for example where the catalyst is selected from the group consisting of beta zeolite, ZSM-5 zeolite, mordenite, silico-aluminophosphate, metal-impregnated zeolite including Fe-zeolite or Cu-zeolite, and combinations thereof, are highly effective.

In general, the disclosed methods will most frequently be practiced in embodiments where the reductant is introduced into and present in the exhaust stream in a proportion at least stoichiometrically sufficient convert the nitrogen oxides in the exhaust stream to nitrogen and water. Such embodiments include those where the exhaust gas stream is introduced into the honeycomb catalyst structure at a flow rate and temperature sufficient to achieve the reduction and removal of at least 45% of the nitrogen oxides in the exhaust at catalyst inlet temperatures of 250° C. and above. For reasons of economy, including catalyst cost control and honeycomb catalyst pressure drop reduction, embodiments of the disclosed methods will include those wherein the channel walls of the selected honeycomb catalyst have a thickness sufficiently reduced to provide a catalyst utilization factor of at least 80%.

The following illustrative example describes the production and use of a representative honeycomb catalyst structure in accordance with the disclosure.

### EXAMPLE

A honeycomb SCR catalyst is manufactured from a metal-impregnated ZSM-5 zeolite powder. To prepare the zeolite powder, a saturated aqueous solution of ferrous gluconate comprising about 10% ferrous gluconate and the remainder water by weight is provided. A commercially available ZSM-5 zeolite powder is then added to the solution to produce a thin zeolite slurry comprising zeolite and gluconate solution in a ratio of 1:1 by weight. The slurry is then spray-dried to produce an iron-zeolite powder.

A plasticized mixture comprising the iron-zeolite powder is next prepared for forming into an extruded honeycomb catalyst. A blended powder mixture is first produced by combining the spray-dried iron-zeolite powder with a powdered alumina matrix material in a proportion of 40 parts iron-zeolite to 60 parts alumina by weight. The alumina matrix material is a calcined Alcoa® A-16 alumina powder.

An aqueous silicone emulsion to serve as a liquid vehicle and permanent binder is then added to the powder mixture along with a quantity of a methyl cellulose powder to serve as a temporary binder, with the resulting mixture then being worked into a plastic mass. The amount of silicone emulsion added is sufficient to plasticize the powder mixture, and the amount of methyl cellulose added is sufficient to permit the plasticized material to maintain shape integrity upon drying.

The plasticized mixture thus provided is next extruded through a honeycomb extrusion die to form a wet honeycomb shape, and the wet shape is air-dried in an oven to produce a dried green honeycomb preform. The honeycomb preform thus provided is then calcined at 850° C. to produce a strong honeycomb catalyst structure. The cell density and slot discharge slot width of the honeycomb extrusion die are selected such that the extruded honeycomb catalyst structure has a cell density of 400 cells/in² and a channel wall thickness of 0.006 in. (150 microns) following drying and calcining.

Testing of the honeycomb catalyst thus provided is carried out utilizing a synthetic exhaust gas comprising an air stream containing 500 parts per million (volume) of nitrogen oxide (NO) and 500 parts per million (volume) of ammonia. Small honeycomb catalyst samples of cylindrical shape, each approximately 2.5 cm in diameter and 2.5 cm in length with the honeycomb channels running parallel with the cylinder length, are cut from the extruded honeycomb catalyst structure for testing. Testing involves passing the synthetic exhaust gas through the honeycomb samples at a space velocity of 20,000 hr⁻¹ while raising the temperature of the gas as measured at the honeycomb inlet surface from 150° C. to 450° C. In the course of this testing the catalyst samples are found to convert in excess of 50% of the available NO and ammonia to nitrogen and water at a gas inlet temperature of 250° C. and more than 90% of the NO and ammonia to nitrogen and water at a gas inlet temperature of 310° C.

Table II below summarizes honeycomb SCR catalyst performance data for various honeycomb SCR catalyst designs of similar catalyst composition under modeled conversion testing conditions such as above described. Catalyst embodiments within the scope of the disclosure, as well as comparative embodiments that exhibit performance or cost problems such as excessive pressure drops, low NO conversion efficiencies, and/or low levels of catalyst utilization, are illustrated. Included in Table II for each of the honeycomb catalyst designs evaluated are values for honeycomb cell density, honeycomb channel wall thickness, honeycomb pressure drop, nitrogen oxide (NO) conversion efficiency, and catalyst utilization factor.

The data in Table II are representative of the characteristics of honeycomb SCR catalysts of approximately 15 cm diameter and 15 cm channel length. The pressure drop values for the catalysts are calculated at an airflow rate yielding a space velocity of 20,000 hr⁻¹ through the honeycombs. The catalytic conversion efficiencies are for the case of a synthetic exhaust gas comprising 5.00 ppm (volume) each of NH₃ and NO, that gas passing through the catalysts at the 20,000 hr⁻¹ space velocity and at a gas temperature of 250° C. as measured at the catalyst inlet surface.

TABLE II
Honeycomb SCR Catalyst Designs

| | | Wall | | | |
|---|---|---|---|---|---|
| | Cell | Thickness | Total | NO Con- | Catalyst |
| | Density | (mils/ | Pressure | version | Utilization |
| | (cells/in²) | microns) | Drop (Pa) | (%) | (%) |
| Catalyst | | | | | |
| Example No. | | | | | |
| 2 | 400 | 10/250 | 106.7 | 62.5 | >80 |
| 3 | 600 | 4/100 | 98.7 | 48.4 | >95 |
| 4 | 400 | 6/150 | 72.9 | 52.6 | >90 |
| 5 | 350 | 10/250 | 87.7 | 60.4 | >80 |
| Comparative | | | | | |
| Catalyst | | | | | |
| Example No. | | | | | |
| 1C | 900 | 2/50 | 125.3 | 35.4 | >95 |
| 2C | 600 | 2/50 | 79.9 | 30.1 | >95 |
| 3C | 400 | 4/100 | 61.0 | 42.1 | >95 |
| 4C | 200 | 16/400 | 61.6 | 55.3 | >70 |
| 5C | 200 | 6/150 | 31.5 | 41.6 | >90 |
| 6C | 100 | 16/400 | 22.6 | 45.0 | >70 |

As the data in Table II reflect, at channel wall thicknesses above about 10 mils, NO conversion efficiency can be high but catalyst utilization can fall below 80%, resulting in excessive catalyst cost. Comparative example 4C is illustrative. On the other hand, at cell densities substantially below 400 cells/in², e.g., below 350 cells/in², achieving 45% NO conversion levels at 250° C. and at space velocities of 20,000 hr⁻¹ within channel lengths of 15 cm can be difficult unless channel wall thicknesses are high. Comparative example 6C, for example, achieves adequate NO conversions, but at a catalyst utilization of only 70%. Finally, catalyst designs featuring high cell densities, such as comparative example C1, will typically exhibit excessive pressure drops, while reducing cell densities to reduce pressure drops, as in comparative example C2, can result in inadequate conversion efficiencies.

Based on analyses of competing designs from data such as presented in the drawings and in Table II above, honeycomb SCR catalysts comprising a selective catalytic reduction catalyst distributed within the channel walls of the structure and offering the combined advantages of high conversion efficiency, low pressure drop, and a high level of catalyst utilization can be provided within a cell density range of 350-600 cells/in² and a channel wall thickness range of 100-250 microns. Within those ranges, lower pressure drops in combination with higher conversion efficiencies can then be realized through the selection of lower channel wall thicknesses where higher cell densities are to be employed.

From the foregoing descriptions and examples it is apparent that the disclosed principles of SCR honeycomb catalyst design and use are applicable to a broader range of catalysts and applications, and may be readily extended to other honeycomb monoliths of solid catalyst construction to insure high catalyst utilization, increased catalytic efficiency, and reduced catalyst cost. Thus a variety of modifications and adaptations of the particular catalysts and methods disclosed herein may be utilized by those of ordinary skill in the art without departing from the spirit and scope of the appended claims.

1. A honeycomb structure having channel walls consisting essentially of a selective catalytic reduction catalyst, wherein the channel walls occupy at least 20% of the volume of the structure and the structure exhibits a pressure drop for flowing air not exceeding 110 Pa at a space velocity of 20,000 hr⁻¹.

2. The honeycomb structure of claim 1 having a channel wall thickness not exceeding 250 microns.

3. The honeycomb structure of claim 1 wherein the selective catalytic reduction catalyst comprises a zeolitic or molecular sieve material.

4. The honeycomb structure of claim 3 wherein the selective catalytic reduction catalyst is selected from the group consisting of beta zeolite, ZSM-5 zeolite, mordenite, silico-aluminophosphate, metal-impregnated zeolite, and combinations thereof.

5. The honeycomb structure of claim 1 providing a nitrogen oxide conversion efficiency of at least 45% when processing a gas mixture comprising 500 ppm (volume) of ammonia and 500 ppm (volume) of nitrogen oxide (NO) in air at a space velocity of 20,000 hr⁻¹ and a gas mixture temperature of 250° C.

6. The honeycomb structure of claim 5 having honeycomb channel length of at least 15 cm and a catalyst utilization factor of at least 80%.

7. The honeycomb structure of claim 5 having a cell density of at least 350 channels per square inch of a transverse honeycomb cross-section.

8. The honeycomb structure of claim 7 having a cell density of from about 350 to about 600 channels per square inch of transverse honeycomb cross-section and a channel wall thickness of about 100 to about 250 microns.

9. A honeycomb catalyst structure comprising channel walls composed of a selective catalytic reduction catalyst, said catalyst comprising a dispersion of a pure catalyst within a solid matrix material for binding the pure catalyst into said walls, the structure having a cell density in the range of 350-600 cells/in2 and a channel wall thickness in the range of 100-250 microns.

10-16. (canceled)

17. A honeycomb structure having channel walls consisting essentially of a selective catalytic reduction catalyst, wherein the honeycomb structure:
has a cell density of from about 350 to about 600 channels per square inch of transverse honeycomb cross-section;
comprises channel walls having a wall thickness of about 100 to about 250 microns, said channel walls occupying at least 20% of the volume of the structure;
exhibits a pressure drop for flowing air not exceeding 110 Pa at a space velocity of 20,000 hr⁻¹, and
provides a catalyst utilization factor of at least 80% and a nitrogen oxide conversion efficiency of at least 45% when processing a gas mixture comprising 500 ppm (volume) of ammonia and 500 ppm (volume) of nitrogen oxide (NO) at a gas mixture temperature of 250° C. and a space velocity of 20,000 hr⁻¹.
